(19) United States
(12) Patent Application Publication
(10) Pub. No.: US 2014/0278581 A1
(43) Pub. Date: Sep. 18, 2014

(54) ZIP RATOR

(71) Applicants: Gregory Scott Fasking, Mountain Brook, AL (US); Matthew Joseph Varagona, Hoover, AL (US); Roswell Tanner Sheehan, Woodstock, GA (US); Randall Barry Ralston, Trussville, AL (US)

(72) Inventors: Gregory Scott Fasking, Mountain Brook, AL (US); Matthew Joseph Varagona, Hoover, AL (US); Roswell Tanner Sheehan, Woodstock, GA (US); Randall Barry Ralston, Trussville, AL (US)

(73) Assignee: Infinity Insurance Company, Birmingham, AL (US)

(21) Appl. No.: 14/211,690

(22) Filed: Mar. 14, 2014

Related U.S. Application Data
(60) Provisional application No. 61/781,407, filed on Mar. 14, 2013.

(51) Int. Cl. G06Q 40/08

(52) U.S. Cl. CPC G06Q 40/08
USPC 705/4

(57) ABSTRACT

A method of providing an insurance rate comprising storing combinations rates based on fields of information in a database, receiving a piece of information relating to one of the fields of information, and pulling an insurance rate based a pre-calculated average of premiums for individuals.

### CROSS REFERENCE TO RELATED APPLICATION

This application claims the benefit of U.S. provisional application 61/781,407, filed Mar. 14, 2013 the disclosures which are incorporated herein by reference in their entirety.

### FIELD OF INVENTION

This invention relates to providing an insurance rate to a customer.

### BACKGROUND OF THE INVENTION

Typically, for a potential customer to obtain a rate for auto insurance, he or she must enter a certain amount of personal information into a rating interface before a rate is returned. In this case, a price is not presented to a customer until a substantial amount of information is collected. Our invention differs in that it presents the customer with a rate based on any combination of known and unknown data elements.

### SUMMARY OF THE INVENTION

This invention relates to a method of providing an insurance rate comprising storing combinations rates based on fields of information in a database, receiving a piece of information relating to one of the fields of information, and pulling an insurance rate based a pre-calculated average of premiums for individuals.

This invention also relates to a method of providing an insurance rate estimate comprising pre-calculating and storing in a database averages for possible combinations of customer information, obtaining a piece of information from an individual that makes up one of the combinations, and preparing a rate based on the information provided by the individual.

This invention further relates to a method of providing an insurance quote, comprising gathering a single piece of information from an individual, making assumptions about unknown attributes of the individual base on the single piece of information, and presenting an insurance rate to the customer based on the one known piece of information and the made assumptions.

### BRIEF DESCRIPTION OF THE DRAWINGS

FIG. 1 shows a flow chart of an embodiment of the invention.

FIG. 2 shows a web page display of the invention.

FIG. 3 shows a web page display with an insurance rate provided by the invention.

FIG. 4 shows a mobile smart phone display provided by the invention.

FIG. 5 shows a mobile smart phone display with an insurance raw provided by the invention.

FIG. 6 shows a direct mail offer having information provided by the invention.

### DETAILED DESCRIPTION OF THE INVENTION

Our invention allows us to present an individual with an insurance rate after we have any single piece of information about that individual.

Typically, for a potential customer to obtain a rate for auto insurance, he or she must enter a certain amount of personal information into a rating interface before a rate is returned. In this case, a price is not presented to a customer until a substantial amount of information is collected. Our invention differs in that it presents the customer with a rate based on any combination of known and unknown data elements. As data elements are successively gathered, our invention refines the rate based on a set of dynamic assumptions. Therefore, our invention allows us to present an accurate price during any stage of a customer interaction, beginning with the first piece of information collected about the customer.

The rates that are displayed are based on calculated averages and distributions related to the known data elements. For example, when we gather a single piece of information such as an individual's geographic location of residence, we use our historical knowledge of trends within that geography to make assumptions on all other unknown attributes, such as financial responsibility, prior insurance status, vehicles driven, driving record, etc. A rate is presented to the customer based on the one known piece of information and the set of assumptions. If we then receive another piece of information about the customer, we dynamically adjust all of the other assumptions based on both pieces of information, and identify another more-accurate rate. Our decision to display or not display an available rate at any point in the customer interaction is governed by website performance analytics. We continue to refine the rate as more information is gathered until the customer either exits our interface or reaches a point where all of the assumptions have been replaced with actual information, at which point the rate is considered a firm quote ready for submission as an application.

Technical Generation and Archiving of Rates:

Our invention involves a two-stage approach to presenting accurate rates to a customer. The first stage utilizes an archive of common combinations stored in a database table or in-memory for quick retrieval. Many of the most frequently encountered combinations of actual and assumed information are pre-calculated, aggregated, and stored. This archive of combination rates is updated frequently and dynamically to reflect analysis of information gathered from actual customers. Fields in the table or in-memory contain items such as garaging zip code, primary named insured marital status, number of drivers, number of vehicles, and vehicle type. Fields are not limited to items used in the actual rate order of calculation for the Insurance product. The archive contains any item that assists in the presentment of a most accurate rate to a given individual. Items include, but are not limited to, proprietary financial responsibility scores, underwriting details, and geographic/demographic indices. New fields may be added at will to improve the performance of the customer facing application.

At a point in the customer information gathering process, it is more efficient to calculate a rate based directly on gathered information and assumptions than it is to look up a rate from a pre-stored archive. This second stage involves the dynamic insertion of assumptions and actual information into our rating application to generate a rate. The set of information that prompts a second stage rate is determined and refined dynamically to optimize interface performance.

The two stages do not necessarily occur sequentially. For example, we may obtain a bulk set of information from an individual that prompts the immediate use of the second stage of our process. A user may then remove certain element that prompts the use of the first stage of our process.

Example Uses of Our invention:

1. Display rates quickly on our website for any customer for whom data is gathered.

2. Present rates on mobile devices or on other electronic devices whose browser functionality renders a traditional quoting process inefficient or unwieldy.

3. Extract rates for direct marketing solicitations. We display customized rates on Direct Mail advertisements that send customers to a URL which allows further refinement of rate.

4. Enhance the experience of the agents or brokers who market our products by allowing them to serve their customers more efficiently

5. Provide talking points to our direct-to-consumer call center.

Rate Generation Algorithms Used:

At the a core of all of Infinity's rates are filed rate orders of calculation for our insurance products within a state. An example of a rate order of calculation is Base Rate*Limit/Deductible Factor Advance Quote*Commission Level Factor*Household Structure Factor*Discount Matrix Factor*Market Tier Factor*Household Factor (calculated below)*Excess Vehicle Factor*Business Use*Leased Vehicle*Anti-Lock Brakes*Territory Factor*Model Year Factor*Vehicle Symbol Factor*Vehicle Make Model Factor*Vehicle Make Model Adjustment Factor*Vehicle History Score Factor*Expense Constant+Policy Term Factor*Customer Choice Factor=Coverage Premium. Each item in this calculation represents a numeric factor associated with a piece of information know about an individual and their household.

Our invention uses this as well as data from actual customers to derive rates based on incomplete knowledge of all required information in a full tiled rate order formula. We have a number of algorithms in place that give us options from which we optimize our sales process. Examples and applications of these are as follows:

1. Calculated Average Sold Premium Based on Known Attributes

We apply this algorithm by pre-calculating and storing a large number of averages for possible combinations of customer information. As soon as we obtain information that makes up one of the pre-calculated combinations, we look up the rate and prepare it for display to the customer. For example, if the first piece of information that we receive about an individual is a zip code, we pull the pre-calculated average sold premium for individuals within that geography. If we then find out that this person has three vehicles and two drivers in the household, we then pull an average rate based on that combination.

2. Calculated Range of Sold Premium Based on Known Attributes

As in the past example, we pre-calculate and store rates based on a large number of combinations of actual customer data. We produce a range of possible premiums based on the mean and standard deviation of the actual sold premium. An example of the use of this method is very similar to the example above—In the case where we first obtain a customer's zip code, we pull a range of sold premium for individuals within that geography. If we then find out further information, we pull ranges based on combinations matching the know information.

3. Minimum Possible Premium Based on Known Attributes

In this case, we pre-calculate and store the minimum possible rate for a large number of combinations of customer attributes. As information is obtained, we pull from this data store to present the best case scenario to a given customer. An example of usage of this is when we obtain attributes on individuals for a direct mail marketing campaign. We then run these attributes through our invention. The lowest possible rate is pulled from the data store and is sent to the printer as variable text for a direct mail offer.

4. Minimum Actual Premium Based on Known Attributes

This algorithm works by pre-calculating and storing the minimum premium paid by a customer for a large number of possible combinations. As information is obtained about a customer, we pull this minimum actual premium from the data store for display to the customer, for example, if we learn that our customer drives a compact SUV, we find the lowest price that any of our customers driving a compact SUV paid in our data store. This is then presented to the customer.

5. Assumed Values in the Rate Order of Calculation

This algorithm works by inserting assumed values for unknown elements into the full filed rate order of calculation. As information is obtained about a customer, we use historical/real-time analytics to predict values for unknown customer data. These are run through our rating application to return a most-accurate rate for the known information. An example usage of this is the case where we know everything about a customer needed for full rating except for his or her history of financial responsibility. Based on other information that we have obtained about this customer, we will make an appropriate assumption about the missing data element. This will then be led into our rating application to calculate the most-accurate rate for the customer.

The utilization of these and/or other algorithms for rate display is guided by sales process optimization. We utilize customer analytics to determine which rate algorithm to use in specific customer situations.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention is therefore not limited to the specific details, representative apparatus and method, and illustrated examples shown and described. Accordingly, departures may be made from such details without departing from the scope or spirit of the invention.

What is claimed is:

1. A method of providing an insurance rate comprising:
a. storing combinations rates based on fields of information in a database,
b. receiving a piece of information relating to one of the fields of information, and
c. pulling an insurance rate based a pre-calculated average of premiums for individuals.

2. A method of providing an insurance rate estimate comprising:
a. pre-calculating and storing in a database averages for possible combinations of customer information,
b. obtaining a piece of information from an individual that makes up one of the combinations, and
c. preparing a rate based on the information provided by the individual.

3. A method of providing an insurance quote, comprising:
a. gathering a single piece of information from an individual,
b. making assumptions about unknown attributes of the individual base on the single piece of information, and
c. presenting an insurance rate to the customer based on the one known piece of information and the made assumptions.

4. The method according to claim 3, further comprising receiving another piece of information about the customer.

5. The method according to claim 4, further comprising dynamically adjusting the assumptions based on the piece and the other piece of information.

6. The method according to claim 5, further comprising identifying another more accurate insurance rate.
